(19) United States
(12) Patent Application Publication
(10) Pub. No.: US 2013/0072705 A1
(43) Pub. Date: Mar. 21, 2013

(54) MANUFACTURE OF HIGH PURITY STEARIN FROM HIGH OLEIC ACID AND LOW PALMITIC ACID SUNFLOWER OIL

(71) Applicant: Dow AgroSciences LLC, Indianapolis, IN (US)

(72) Inventors: Asim Syed, Carmel, IN (US); Carl Vincent DeAmicis, Indianapolis, IN (US); Gregory Todd Whiteker, Carmel, IN (US); Thomas G. Patterson, Westfield, IN (US); Josh Flook, Tipton, IN (US); James Todd Gerdes, Breckenridge, MN (US); Charles James Kahl, Westfield, IN (US); Angela Lee Erickson, Fergus Falls, MN (US); Robert Martin Benson, Ellsworth, WI (US)

(73) Assignee: DOW AGROSCIENCES LLC, Indianapolis, IN (US)

(21) Appl. No.: 13/668,044

(22) Filed: Nov. 2, 2012

Related U.S. Application Data
(63) Continuation-in-part of application No. 12/340,558, filed on Dec. 19, 2008.
Application No. 12/340,558 is a continuation-in-part of application No. 12/340,525, filed on Dec. 19, 2008.
(60) Provisional application No. 61/015,591, filed on Dec. 20, 2007.
(60) Provisional application No. 61/015,591, filed on Dec. 20, 2007.

(51) Int. Cl. C11C 3/12; C07C 67/283

(52) U.S. Cl. CPC C11C 3/12
USPC 554/142; 554/161; 554/1

(57) ABSTRACT

This disclosure concerns methods for producing a high purity stearin comprising, for example, providing a sunflower oil comprising no more than about 4% total saturated fat and hydrogenating the sunflower oil. By way of further example, a method for producing a high purity tristearin may comprise providing sunflower oil comprising at least about 88% oleic acid and hydrogenating the sunflower oil. High purity stearin produced by methods, such as the foregoing, are also disclosed.

### CROSS-REFERENCE TO RELATED APPLICATIONS

This application is a continuation-in-part of co-pending U.S. patent application Ser. No. 12/340,558, filed Dec. 19, 2008, and U.S. patent application Ser. No. 12/340,525, filed Dec. 19, 2008, the contents of the entirety of each of which is incorporated herein by this reference. U.S. patent application Ser. No. 12/340,558 and U.S. patent application Ser. No. 12/340,525 both claim priority under 35 U.S.C. §119(e) to U.S. Provisional Patent Application Ser. No. 61/015,591, filed Dec. 20, 2007.

### FIELD OF THE DISCLOSURE

The present disclosure relates to the production of stearin by hydrogenation of novel sunflower oils comprising high oleic acid and/or low palmitic acid/saturated fat. Some aspects of the disclosure relate to the production of the triglyceride of stearic acid from particular sunflower germplasm that is characterized by stabilized oil traits.

### BACKGROUND

Many oils and fats used for preparation of foods are vegetable oils that may typically be extracted from plant seeds. Chemically, vegetable oils include glycerin triesters, and they typically contain fatty acids having 16 to 20 carbon atoms, monoglycerides, diglycerides, and triglycerides. While other “unusual” fatty acids exist in plants, palmitic, stearic, oleic, linoleic, and linolenic acids comprise about 88% of the fatty acids present in the world production of vegetable oils. Harwood, J. L. (1980) “Plant acyl lipids: structure, distribution and analysis.” In The Biochemistry of Plants (P. K. Stumpf and E. E. Conn, eds.), Vol. 4, pp. 1-55. Academic Press, New York.

Through highly labor intensive and uncertain research efforts, elite cultivars of many commercial oil plants have been produced (e.g., through selective breeding, and through recombinant genetic technology) that exhibit stable and characteristic oil traits. Consequently, a number of oilseeds have been introduced over the past several decades that can be used to produce a vegetable oil with characteristic and modified fatty acid compositions. These include canola and soybean oils that are characterized by a low linolenic acid content; corn, soybean, and sunflower oils that are characterized by a high oleic acid content; and soybean oils that are characterized by a high or low level of saturated fatty acids. Many of these oils show promise in reducing trans and/or saturated acids in food oils, for example, because high-oleic acid oils are much more oxidatively stable (and thus may not require hydrogenation), and because high-saturated oils are trans-free.

It is a difficult and uncertain challenge to incorporate and stabilize a trait of interest into high yielding cultivars of commercial crop plants (e.g., sunflower). The difficulty is increased by several orders of magnitude if a breeder attempts to combine multiple traits into one cultivar. For a plant breeder to find a cultivar with sufficient merit (e.g., high yielding) to be increased and commercially distributed, it is necessary to make many crosses and grow thousands of experimental genotypes. The evaluation of so many genotypes is a huge task, and consumes an enormous amount of the plant breeder's time and budget. If the plant breeder is fortunate, it can take a decade or more from the time the original cross is made to the time when a commercially viable genotype is identified. If the plant breeder is unfortunate, a certain trait or combination of traits may be impossible to incorporate into a particular germplasm, where the source of the failure most often is never known or able to be determined.

The effectiveness of selecting for plant genotypes with particular traits of interest in a breeding program will depend upon, inter alia: the extent to which the variability in the traits of interest of individual plants in a population is the result of genetic factors, and is thus transmitted to progeny of the selected genotypes; and how much the variability in the traits of interest among the plants is due to the environment in which the different genotypes are growing. The inheritance of traits ranges from control by one major gene whose expression is not influence by the environment (i.e., qualitative traits) to control by many genes whose effects are influenced by the environment (i.e., quantitative traits).

Breeding for quantitative traits is further characterized by the facts that: the differences resulting from the effect of each gene are small, which makes it difficult or impossible to identify them individually; the number of genes contributing to a trait is large, so that distinct segregation ratios are seldom, if ever, obtained; and the effects of the genes may be expressed in different ways based on environmental variation. Therefore, the accurate identification of transgressive segregants or superior genotypes with characteristic quantitative traits of interest is particularly challenging and uncertain.

The likelihood of identifying a transgressive segregant is greatly reduced as the number of traits combined into one genotype is increased. For example, if a cross is made between cultivars differing in three complex characters, it is extremely difficult to recover simultaneously by recombination the maximum number of favorable genes for each of the three characters into one genotype. Consequently, all the breeder can generally hope for is to obtain a favorable assortment of genes for each of the complex characters combined into one genotype.

The foregoing concerns apply not only to traditionally bred plant lines, but also to lines having one or more transgenes. Whether combining desirable traditional and transgenic traits via hybridization of transgenic lines, or co-transformation of multiple genes into one line, the combined effect on yield are likely to be multiplicative. The likelihood of identifying a line with a suitable combination of traits is further reduced when considering the potential effects of a transgene on the regulation of metabolism within a plant. For example, one can consider the potential effect of genes conferring resistance to imidazolinones. The gene conferring this trait is a gene encoding a mutant acetolactate synthase (ALS) enzyme. The ALS gene affects closely related biochemical reactions in the synthesis of amino acids.

Acceptable lines for the introduction of a specific allele have background genotypes that compensate for or are mainly unaffected by the perturbations caused by the introduced allele. When lines with alleles contributing to multiple traits of interest are combined by breeding, the background genotypes that have adjusted to the introduced alleles are combined, and new genotypes must be selected. The frequency of genotypes with suitable yield will be reduced accordingly. Notwithstanding the foregoing, once a particular combination of traits have been combined in a variety, then the traits can be transferred to other genetic backgrounds.

The cultivated sunflower (Helianthus annuus L.) is a major worldwide source of vegetable oil. Sunflowers are considered oilseeds, along with cottonseed, soybeans and canola, and the growth of sunflower as an oilseed crop has rivaled that of soybean. The oil accounts for 80 percent of the value of the sunflower crop, as contrasted with soybean, which derives most of its value from the meal. In the United States, the major sunflower producing states are the Dakotas, Minnesota, Kansas, Colorado, Nebraska, Texas and California, although most states have some commercial acreage. Sunflower oil production in the United States was 2.26 million pounds in 2003, and oil sunflowers had an average yield of 1,206 pounds per acre.

Sunflower oil is generally considered a premium oil because of its light color, high level of unsaturated fatty acids, lack of linolenic acid, bland flavor, and high smoke point. Sunflower oil generally comprises palmitic (16:0), stearic (18:0), oleic (18:1), linoleic (18:2) and linolenic (18:3) acids in characteristic amounts. The primary fatty acids in sunflower oil are the unsaturated fatty acids, oleic acid and linoleic acid.

Saturated fatty acids generally have higher melting points than an unsaturated fatty acid of the same carbon number. Accordingly, an unsaturated vegetable oil may be partially or completely hydrogenated to increase the melting point of the vegetable oil. In the hydrogenation process (also sometimes referred to as “hardening”), a carbon-carbon double bond is reduced by molecular hydrogen (H₂), thereby forming an alkane from the alkene fatty acid substrate. If all of the carbon-carbon double bonds in the substrate molecule are reduced by this process, the process may be referred to as “complete hydrogenation.” As the hydrogenation of an unsaturated oil proceeds towards completion, the degree of the molecular substrate's saturation increases, while the viscosity and the melting point of the oil correspondingly increase.

The degree of saturation (and hydrogenation) in an oil may be measured by determining the “iodine value” of the oil. The iodine value is the mass of iodine that is consumed by 100 grams of the oil. As discussed above, fatty acid unsaturation is in the form of double bonds, which bonds may react with iodine compounds, as well as with molecule hydrogen. The higher the iodine value of an oil, the more carbon-carbon double bonds are present in the oil. The lower the iodine value of an oil, the higher the degree of saturation/hydrogenation, and the higher the melting point, of the oil.

Stearic acid triglyceride (also referred to as “stearin,” or “tristearin”), is used heavily in the production of food products. Due to its relatively high melting point, its basic uses are as an ingredient in, for example, shortenings, margarines and spreads, dairy powders, and coffee whiteners. In such products, stearin may function to impart a desired texture to the final product (e.g., at room temperature). Also, stearin may be included in liquid oils (e.g., soybean, corn, and canola oil) to fry potatoes, such as in the preparation of French fries. In this application, the stearin provides the creamy and buttery mouth feel to the fried potatoes. Stearin also has many industrial uses, including, for example, in lubrication; pyrotechnics; soaps; candle wax; dispersing agents; and shoe and metal polishes.

Saturated fatty acids are abundantly present in certain natural fats, for example, cocoa butter; palm oil; palm kernel oil; coconut oil; and tallow. Although hard structural fats suitable for producing structured products are naturally available, fats with a solid structure and a major fatty acid chain ranging from C14 to C20 are typically obtained by hydrogenation of liquid vegetable oils (e.g., soy, rapeseed, sunflower, and groundnut oil). However, hydrogenation not only involves conversion of unsaturated fatty acids into saturated fatty acids, but also conversion of cis-unsaturated fatty acids into trans-isomers of partially hydrogenated fatty acids. For nutritional reasons, it is typically highly desirable to limit the amount of saturated and partially hydrogenated fatty acids in a food product. It is particularly desirable to limit the amount of trans-unsaturated fatty acids in food products. It has been demonstrated that consumption of saturated and partially hydrogenated fatty acids increases the risk of cardiovascular diseases.

### BRIEF SUMMARY OF THE DISCLOSURE

Described herein are methods for producing a high purity stearin. A high purity stearin produced by such a method is also described. In some embodiments, a high purity stearin may be produced from a sunflower oil comprising a low saturated fat content (and/or a low palmitic acid content, in particular) that is characteristic of the sunflower variety from which the sunflower oil was obtained. In some embodiments, a high purity stearin may be produced from a sunflower oil comprising a high oleic acid content that is characteristic of the sunflower variety from which the sunflower oil was obtained. In other embodiments, a high purity stearin may be produced from a sunflower oil comprising a low saturated fat content and a high oleic acid content, which oil traits are characteristic of the sunflower variety from which the sunflower oil was obtained.

A method for producing a high purity stearin may comprise in particular embodiments, for example, providing the sunflower oil, and hydrogenating the sunflower oil to produce stearin. Particular examples include methods for producing a high purity stearin from the sunflower oil of one or more specific sunflower varieties that are characterized, at least in part, by producing an oilseed that comprises a low saturated fat content and/or a high oleic acid content. Thus, particular examples include methods for producing a high purity stearin from a raw (i.e., unprocessed) sunflower oil comprising a characteristic low saturated fat content and/or a characteristic high oleic acid content. Examples of specific sunflower varieties capable of producing such a particular raw sunflower oil include, for example and without limitation, a sunflower variety set forth in Table 2 or Table 3.

In some embodiments, a method for producing a high purity stearin is provided, wherein the method may comprise providing a sunflower oil comprising about 4% or less total saturated fatty acids, and hydrogenating the sunflower oil. In particular embodiments, the method may comprise providing a sunflower oil comprising, for example and without limitation, 4.2% or less; 4.1% or less; 4.0% or less; about 3.9% or less; about 3.8% or less; about 3.6% or less; about 3.4% or less; about 3.3% or less; about 3.2% or less; about 3.1% or less; about 3.0% or less; about 2.9% or less; about 2.8% or less; about 2.6% or less; about 2.4% or less; about 2.2% or less; and between about 4% and about 2% saturated fatty acids. Particular examples include methods for producing a high purity stearin from the sunflower oil of one or more specific sunflower varieties that are characterized, at least in part, by producing an oilseed that comprises an oil having about 4% or less total saturated fatty acids. Examples of such specific sunflower varieties include, for example and without limitation, a sunflower variety set forth in Table 2.

In some embodiments, a method for producing a high purity stearin is provided, wherein the method may comprise providing sunflower oil comprising at least about 80% oleic acid; and hydrogenating the sunflower oil. In particular embodiments, the method may comprise providing a sunflower oil comprising, for example and without limitation, at least about 80% (e.g., at least 79%, at least 79.5%, at least 80%, at least 80.5%, and at least 81%); at least about 81%; at least about 82%; at least about 83%; at least about 84%; at least about 85%; at least about 86%; at least about 87%; at least about 88%; at least about 89%; at least about 90%; at least about 91%; at least about 92%; at least about 93%; at least about 94%; at least about 95% oleic acid; and between about 80% and about 96% oleic acid. Particular examples include methods for producing a high purity stearin from the sunflower oil of one or more specific sunflower varieties that are characterized, at least in part, by producing an oilseed that comprises an oil having at least about 88% oleic acid. Examples of such specific sunflower varieties include, for example and without limitation, a sunflower variety set forth in Table 4.

In some embodiments, a method for producing a high purity stearin is provided, wherein the method may comprise providing sunflower oil comprising at least about 93% combined C18 fatty acids; and hydrogenating the sunflower oil. In particular embodiments, the method may comprise providing a sunflower oil comprising, for example and without limitation, at least about 93% (e.g., at least 92%, at least 92.5%, at least 93%, at least 93.5%, and at least 94%); at least about 93.5%; at least about 94%; at least about 94.5%; at least about 95%; at least about 95.5%; at least about 96%; at least about 96.5%; and at least about 97% combined C18 fatty acids. Particular examples include methods for producing a high purity stearin from the sunflower oil of one or more specific sunflower varieties that are characterized, at least in part, by producing an oilseed that comprises an oil having at least about 93% combined C18 fatty acids. Examples of such specific sunflower varieties include, for example and without limitation, a sunflower variety set forth in Table 2 and Table 3.

In some embodiments, a method for producing a high purity stearin is provided, wherein the method may comprise providing sunflower oil comprising about 3% or less palmitic acid. Examples of such specific sunflower varieties include, for example and without limitation, a sunflower variety set forth in Table 5. In some embodiments, a method for producing a high purity stearin is provided, wherein the method may comprise providing sunflower oil comprising about 3.5% or less total combined palmitic acid and stearic acid. In some embodiments, a method for producing a high purity stearin is provided, wherein the method may comprise providing sunflower oil comprising at least about 88% oleic acid and about 3% or less palmitic acid. Examples of such specific sunflower varieties include, for example and without limitation, a sunflower variety set forth in Table 6.

In particular embodiments, a method for producing a high purity stearin may comprise hydrogenation of a particular sunflower oil (e.g., as set forth, supra). Hydrogenation in such a method may comprise, for example and without limitation, dissolving the particular sunflower oil in a solvent; hydrogenation utilizing a metal catalyst (e.g., Ni, Pd, Pt, Rh, and Ru); hydrogenation at ambient temperature; hydrogenation at an elevated (i.e., higher than ambient) temperature; hydrogenation at an ambient pressure; and hydrogenation at an elevated (i.e., higher than ambient) pressure, so as to produce the high purity tristearin.

Methods for using a high purity stearin described herein are also provided in some embodiments. For example, a high purity stearin described herein may be blended with one or more oil(s) (e.g., a high oleic acid, low linolenic acid vegetable oil) in a food product, for example, to impart a desired texture to the food product. By way of further example, a high purity stearin described herein may be used in any industrial process or application where a stearin may be used that is known by those of skill in the art.

The foregoing and other features will become more apparent from the following detailed description of several embodiments.

### DETAILED DESCRIPTION

### I. Overview of Several Embodiments

Most edible and industrial stearin used in the United States is manufactured from hydrogenated vegetable oils, or else is made as a byproduct from tallow and lard fractionation. Conventional hydrogenated vegetable oils used to manufacture stearin contain a combination of stearic and palmitic acids, since the vegetable oil used as a reagent is comprised of a combination of different fatty acids. In order to produce stearin with some level of purity, it has to be separated through energy-intensive processes, such as hydrolysis and molecular distillation. Embodiments of the current invention include a new and improved method for producing a high purity stearin that may reduce or eliminate the need for certain processing steps (e.g., separation through hydrolysis or molecular distillation) that are a hindrance in the prior art.

Embodiments of the invention utilize particular raw sunflower oils, or mixtures of the same, to manufacture stearin. One benefit of this raw material in some embodiments is that it has a high oleic acid content that was previously unobtainable in a raw sunflower oil, which, when fully hydrogenated, produces high purity (e.g., at least about 96%) stearin. Such high purity stearin is, for all practical purposes, as potent as 100% stearin. A further benefit of this raw material in some embodiments is that an unusually high amount of the starting oil is monounsaturated, and thus only one H₂ molecule per fatty acid is needed to complete the saturation. This results in the reduced consumption of hydrogen gas, energy for heating, and processing time during the hydrogenation.

In detailed examples described herein, high oleic acid sunflower oils and RSS sunflower oils have been fully hydrogenated using toluene solvent and 5% palladium on carbon catalyst at hydrogen pressures ranging from 40-50 psi. These examples demonstrate the successful production of a high purity stearin without the need for hydrolysis or molecular distillation. A high purity stearin produced by a method according to embodiments may be precipitated out of solution in crystalline form by the addition of an anti-solvent (e.g., ethyl acetate), or it may be isolated by evaporation of the solvent.

### II. Abbreviations

FAME fatty acid methyl ester
GC gas chromatography
IV iodine value
NIR near infrared spectroscopy
NMR nuclear magnetic resonance spectroscopy
RSS reduced saturate sunflower
TOTSAT total saturated fat content

### III. Terms

In the description and tables which follow, a number of terms are used. In order to provide a clear and consistent understanding of the specification and claims, including the scope to be given such terms, the following definitions are provided.

Characteristic: As used herein with regard to traits and phenotypes, the term “characteristic” denotes that a particular plant or cultivar may be identified by the existence of the trait/phenotype. For example, a “characteristic trait” in an elite sunflower cultivar may be an observable trait that distinguishes the elite sunflower cultivar from other cultivars. It is understood in the art that the extent to which a characteristic trait is observable in a plant may be influenced by other than genetic factors (e.g., it may be influenced in part by environmental factors). However, a characteristic trait is subject to a very significant level of genetic control, such that a cultivar comprising the characteristic trait may be used in practice to identify and distinguish the cultivar from other cultivars. In certain embodiments herein, characteristic traits of particular interest in sunflower are reduced levels of saturated fatty acids and high oleic acid content.

Elite: An “elite” sunflower cultivar is one which has been stabilized for certain commercially important agronomic traits comprising a stabilized yield of about 100% or greater relative to the yield of check varieties in the same growing location growing at the same time and under the same conditions. An “elite sunflower” in certain examples may refer to a sunflower cultivar stabilized for certain commercially important agronomic traits comprising a stabilized yield of 110% or greater (e.g., 115% or greater), relative to the yield of check varieties in the same growing location growing at the same time and under the same conditions.

Fatty acid: As used herein, the term “fatty acid” refers to a long chain (more than 8-10 carbon atoms) straight- or branched-saturated, monounsaturated, or polyunsaturated hydrocarbon chain bonded to a terminal carboxyl group. The term “fatty acid” also encompasses the fatty acid moieties of monoglycerides, diglycerides and triglycerides, which are the major constituents of sunflower oils.

Fatty acid content: As used herein, the term “fatty acid content” refers to the relative concentration of each fatty acid in an oil. Examples of particular fatty acids, the relative concentration of which may be determined in an oil (e.g., via FAME analysis), includes without limitation: oleic acid (18:1); linoleic acid (18:2); lauric acid (C12:0); myristic acid (C14:0); palmitic acid (C16:0); stearic acid (C18:0); arachidic acid (C20:0); behenic acid (C22:0); and lignoceric acid (C24:0).

The percentage of total fatty acids can be determined by extracting a sample of oil from seed, producing the methyl esters of fatty acids present in that oil sample, and utilizing GC to analyze the proportions of the various fatty acids in the sample. The fatty acid composition can also be a distinguishing characteristic of a variety.

Total saturated fat content (TOTSAT): As used herein, “TOTSAT” refers to the total percent oil of the seed of the saturated fats in the oil. Saturated fats that may be found in an oil include, for example: C12:0; C14:0; C16:0; C18:0; C20:0; C22:0; and C24:0.

Fatty acid methyl ester (FAME) analysis: FAME analysis is a method that allows for accurate quantification of the fatty acids that make up complex lipid classes. In a typical FAME analysis, fatty acid methyl esters are created through an alkali-catalyzed reaction between fats or fatty acids in a sample and methanol. The fatty acid methyl esters can then be analyzed utilizing gas chromatography (GC).

High purity stearin: As used herein, the term “high purity stearin” may refer to a hydrogenated sunflower oil comprising a combined stearic acid and palmitic acid content of at least about 97% of the total fatty acids in the oil, and a stearic acid content of at least about 90% of the total fatty acids in the oil. Thus, in certain examples, a “high purity stearin” is a hydrogenated sunflower oil comprising a combined stearic acid and palmitic acid content of, for example, at least 96.5%; at least 97.0%; at least 97.5%; at least about 98.0%; at least about 98.5%; at least about 99.0%; and at least about 99.5% of the total fatty acids in the oil, and a stearic acid content of, for example, at least 89%; at least 90%; at least 91%; at least about 92%; at least about 93%; at least about 94%; at least about 95%; at least about 96%; and at least about 97% of the total fatty acids in the oil. A “high purity stearin” may also be fully saturated or essentially fully saturated (i.e., at least about 97%, at least about 97.5%, at least about 98.0%; at least about 98.5%; at least about 99.0%; and/or at least about 99.5% of the total fatty acids in the oil are saturated fatty acids).

Oil content: The “oil content” of a seed or plant cultivar is typically expressed as a mass percentage of the whole dried seed of the cultivar. Oil content is a characteristic trait of different elite sunflower cultivars. Oil content may be determined using any of various analytical techniques including, for example and without limitation: NMR; NIR; and Soxhlet extraction.

Stabilized: As used herein in regard to traits/phenotypes, the term “stabilized” refers to traits/phenotypes that are reproducibly passed from one generation to the next generation of inbred plants of the same variety.

### IV. Hydrogenation of RSS (Reduced Saturate Sunflower) Oil and High Oleic Acid Sunflower Oil

Some embodiments include a method for producing a high purity stearin by hydrogenating a sunflower oil having a low saturated fat content. A sunflower oil having a low saturated fat content may include, for example and without limitation: about 4% or less (e.g., 4.2% or less, 4.1% or less, 4.0% or less, about 3.9% or less, and about 3.8% or less); about 3.6% or less; about 3.4% or less; about 3.3% or less; about 3.2% or less; about 3.1% or less; about 3.0% or less; about 2.9% or less; about 2.8% or less; about 2.6% or less; about 2.4% or less; about 2.2% or less; and between about 4% and about 2% total combined palmitic acid (16:0) and stearic acid (18:0) content. For example, the sunflower oil may be derived from at least one sunflower plant that is stabilized for the characteristic production of seeds comprising a decreased saturated fat content.

Sunflower plants that are stabilized for the characteristic production of seeds comprising a decreased saturated fat content include, for example, the sunflower varieties set forth in Table 2 and Table 3 of the Examples. Seed from plants of any of these sunflower cultivars may be utilized in some embodiments to provide a sunflower oil having a low saturated fat content, from which is to be produced a high purity stearin.

A sunflower oil having a low saturated fat content may specifically comprise a low palmitic acid content, for example and without limitation: about 3% or less (e.g., 3.2% or less, 3.1% or less, 3.0% or less, about 2.9% or less, and about 2.8% or less); about 2.8% or less; 2.6% or less; about 2.4% or less; about 2.3% or less; about 2.2% or less; about 2.1% or less; about 2.0% or less; about 1.9% or less; about 1.8% or less; about 1.7% or less; about 1.6% or less; about 1.5% or less; about 1.4% or less; and between about 3% and about 1.3% palmitic acid. For example, the sunflower oil may be derived from at least one sunflower plant that is stabilized for the characteristic production of seeds comprising a decreased saturated fat content.

Sunflower plants that are stabilized for the characteristic production of seeds comprising a decreased saturated fat content and, specifically, a low palmitic acid content include, for example, the sunflower varieties set forth in Table 5 of the Examples. Seed from plants of any of the foregoing sunflower cultivars may be utilized in some embodiments to provide a sunflower oil having a low palmitic acid content, from which is to be produced a high purity stearin.

In some embodiments, a high purity stearin may be produced by a method comprising the hydrogenation of a sunflower oil comprising a high (e.g., at least about 80%, at least 88.66%, and at least about 90%) oleic acid content. A sunflower oil having high oleic acid content provides increased oxidative stability relative to those including a high polyunsaturated fat content such as, for example, conventional sunflower oils and conventional canola oils. A high oleic acid sunflower oil may be derived from sunflower seeds produced by a plant that has been genetically modified to yield a characteristic high oleic content, for example, an Omega-9® (Dow AgroSciences LLC, Indianapolis, Ind.) sunflower oil. Omega-9® sunflower oil is a sunflower oil having an oleic acid (18:1) content of at least about 80% (e.g., at least 79%, at least 79.5%, at least 80%, at least 80.5%, and at least 81%), and an α-linolenic acid (18:3) content of less than about 1%. For example and without limitation, an Omega-9® sunflower oil may comprise at least about 81%; at least about 82%; at least about 83%; at least about 84%; at least about 85%; at least about 86%; at least about 87%; at least about 88%; at least about 89%; at least about 90%; at least about 91%; at least about 92%; at least about 93%; at least about 94%; at least about 95% oleic acid; and between about 80% and about 96% oleic acid.

Sunflower plants that are stabilized for the characteristic production of seeds comprising a high oleic acid content include, for example, the sunflower varieties set forth in Table 4 of the Examples. Seed from plants of any of the foregoing sunflower cultivars may be utilized in some embodiments to provide a sunflower oil having a high oleic acid content, from which is to be produced a high purity stearin.

In some embodiments, a high purity stearin may be produced by a method comprising the hydrogenation of a sunflower oil comprising a low saturated fat (e.g., palmitic acid (16:0)) content and a high oleic acid content. The combination of high oleic acid content with low palmitic acid content allows for hydrogenation of the oil to produce a high purity stearin hard fat through use of a simple manufacturing process comprising full hydrogenation of the oil. Sunflower plants that are stabilized for the characteristic production of seeds comprising a high oleic acid content and a low palmitic acid content include, for example, the sunflower varieties set forth in Table 6 of the Examples. Seed from plants of any of the foregoing sunflower cultivars may be utilized in some embodiments to provide a sunflower oil having a low saturated fat content and high oleic acid content, from which is to be produced a high purity stearin.

In particular examples of sunflower plants that may be utilized to provide a raw sunflower oil for the production of a high purity stearin, the combination of a low palmitic acid trait with a high oleic acid trait results in oilseed with oil profiles containing up to about 94% oleic acid and less than 2.1% palmitic acid. The combination of high C18 fatty acid content with low C16 fatty acids (which was previously unobtainable in a raw sunflower oil) may be exploited to produce what will essentially be reagent grade high purity stearin using a very simple manufacturing process without certain purification steps. Full hydrogenation of this sunflower oil (i.e., converting essentially all of the unsaturated C18 fatty acids to stearic acid) may yield a hard fat comprising a total stearic acid content of at least 96%. In such a hard fat, the contents of stearic and palmitic acids together may account for over 98% of the total fatty acids in the fat.

As previously indicated, particular embodiments of the invention utilize a raw, unprocessed sunflower oil produced by one or more elite sunflower cultivars with the stabilized oil trait(s) of low saturated fat content; low palmitic acid content; and/or high oleic acid content. Oils produced by several such cultivars may be combined in some examples. In others, the oil is produced by a single such cultivar. In addition to the representative suitable sunflower cultivars described in Table 2, Table 3, Table 4, Table 5, and Table 6, it will be understood that other suitable sunflower cultivars may be produced by crossing these representative cultivars, where the oil trait(s) have been successfully and stably combined, with another sunflower cultivar. Further, other suitable sunflower cultivars may be produced by mutagenesis or transformation of the representative cultivars. Some embodiments utilize a sunflower oil produced by one or more such other suitable sunflower cultivar.

Hydrogenation of a high oleic acid and/or low saturated fat (e.g., low palmitic acid) sunflower oil during the production of a high purity stearin according to particular embodiments may be performed according to any of many specific protocols known in the art, such as, for example and without limitation, by heating the oil with metal catalysts in the presence of pressurized hydrogen gas. For example, the hydrogenation may be conducted in a solvent (e.g., toluene, chloroform) or “neat,” and it can be conducted at ambient or elevated (e.g., 80-200° C.) temperatures and ambient or elevated pressures (e.g., 1-5 atms). A variety of metal catalysts may be used in the hydrogenation, including for example and without limitation: nickel (Pricat9910, Raney, etc.); palladium; platinum; rhodium; and ruthenium.

During hydrogenation, hydrogen atoms are incorporated into the fatty acid molecules, such that they become saturated. For example, oleic acid (C18:1) and linoleic acid (C18:2) are both converted to stearic acid (C18:0) when fully saturated. The degree of hydrogenation of the liquid oil can be controlled by known practice, resulting in a range of saturation from partially hydrogenated to fully hydrogenated fats. Through such known techniques, the liquid vegetable oil can become a solid, fully saturated fat.

In particular embodiments, the hydrogenation of a high oleic acid and/or low saturated fat (e.g., low palmitic acid) sunflower oil is performed in the presence of a palladium on activated carbon catalyst. The use of a palladium (or platinum) catalyst reduces the formation of partially saturated trans-isomers during the hydrogenation. Because the heavy metal catalyst is highly toxic, the removal of the catalyst from the product must be almost complete. Thus, a high purity stearin produced by a method according to some embodiments may be subjected to a purification step whereby a catalyst is removed from the stearin. This purification is a separate and distinct process from the separation of stearin from other fatty acids in the product, the elimination of which is a particular benefit of some embodiments.

According to the foregoing, some embodiments of the invention provide a oil product produced by the full or partial hydrogenation of a sunflower oil comprising a low saturated fat content (e.g., a low palmitic acid content) and/or a high oleic acid content. Particular embodiments provide a high purity stearin produced by the full hydrogenation of such a sunflower oil. Oil products of embodiments of the invention may be used in any application (e.g., culinary and industrial) for which the use of stearin is desired. A particular benefit of the high purity stearin provided in some embodiments is that it is suitable for use in applications where a reagent grade stearin is desired, but without certain costly processing steps.

In specific applications, an oil blend comprising a high purity stearin may be used as a “reduced calorie” fat source. Numerous studies have indicated that tristearin is not broken down or taken up in the digestive tract, and is excreted essentially intact. Thus, the food processing functionality of a hard fat can be achieved without the added caloric load of normal saturated fats, such as lard. Furthermore, a high purity stearin may be combined with one or more other oil(s) to produce a blended oil product. For example, a high purity stearin may be combined with one or more liquid oil(s) (e.g., an Omega-9® oil) in a blended shortening. By way of further example, a high purity stearin may be used in a blended frying oil. Fully-hydrogenated fats have a relatively high oxidative stability, so adding a high purity stearin to liquid oil may improve the stability of the resulting blended oil product.

The following examples are provided to illustrate certain particular features and/or embodiments. The examples should not be construed to limit the disclosure to the particular features or embodiments exemplified.

### EXAMPLES

### Example 1

### FAME Protocol Using Saponification and BF₃ Methylation

A Fatty Acid Methyl Ester (FAME) protocol that utilized the saponification and methylation of fatty acids in oil for FAME analysis by GC-FID via boron triflouride (BF₃) was used for the FAME analysis of samples containing high levels of free fatty acids. Samples that contain significant levels of free fatty acids are not converted to methyl esters using traditional methoxide-catalyzed transesterification protocols.

First, about 10 mg (+/−2 mg) of an oil sample was portioned into a labeled 13×100 screw cap tube. Next, 300 μL 0.5N NaOH in methanol was added to each tube. The tubes were placed in a heating block set to 100° C. for 5.0 minutes. Then, the tubes were removed from the heating block and allowed to cool at room temperature for at least 1.0 minute. If the methanol had evaporated, the sample was reconstituted with 300 μL methanol before proceeding.

Next, 350 μL 14% BF₃ in methanol was added to each tube. The tubes were placed in a heating block set to 100° C. for 5.0 minutes, removed from the heat, and allowed to cool at room temperature for at least 1.0 minute.

Next, 2.000 mL heptane was added to each tube. The tubes were placed in a heating block set at 100° C. for 5.0 minutes, removed from the heating block, and allowed to cool at room temperature for at least 1.0 minute.

1.000 mL NaCl saturated Milli-Q™ water was then added to each tube, and the tubes were placed on a rocker for 5.0 minutes at room temperature. The tube was then centrifuged at 2,000 rpm for 10.0 minutes. Finally, 400 μL of supernatant was transferred to a labeled gas chromatography (GC) vial that contained 400 μL of glass insert. The GC vial was capped, and a 1.0-2.0 μL sample was injected into a 6890 Hewlett Packard GC-FID™ with a 7683 AutoSampler™ (Hewlett-Packard, Palo Alto, Calif.), and analyzed according to the instrument parameters provided in Table 1.

TABLE 1
The conditions for sample analysis run in a 6890 Hewlett Packard GC-
FID ™ with a 7683 AutoSampler ™.
Instrument Conditions
General:

| | |
|---|---|
| Front Inlet Type | S/SL EPC |
| Front Injector | — |
| Front Inlet | Yes |
| Column 1 | Yes |
| Front Detector | Yes |
| Channel 1 | Yes |

Column Conditions:

| | |
|---|---|
| Description | DB-23 |
| Length (m) | 60.00 |
| Diameter (μ) | 250 |
| Film Thickness (μ) | 0.25 |
| Gas Type | Helium |
| Mode | Constant Flow |
| Initial Pressure/Flow | 3.0 mL/min |

Oven Conditions:

| | |
|---|---|
| Isocratic Oven | Enable |
| Temperature Ramp | Constant |
| Maximum Temperature | 260° C. |
| Initial Temperature | 210° C. |
| Equilibrium Time | 0.50 minutes |

Injector Conditions - ctcPAL:

| | |
|---|---|
| Available Cycles | Dual GC-Inj3 |
| Syringe Vol | 10 μL |
| Air Volume (μL) | 0 |
| Pre Clean with Solvent 1 | 0 |
| Pre Clean with Solvent 2 | 0 |
| Pre Clean with Sample | 0 |
| Filling Speed (μL/s) | 8 |
| Filling Strokes | 3 |
| Inject to | GC Inj1 |
| Injection Speed (μL/s) | 100 |
| Pre Inject Delay (ms) | 0 |
| Post Inject Delay (ms) | 0 |
| Post Clean with Solvent 1 | 3 |
| Post Clean with Solvent 2 | 3 |

Inlet Conditions:

| | |
|---|---|
| Inlet Type | S/SL EPC |
| Mode | Split |
| Temp Enable | Yes |
| Initial Temp | 280° C. |
| Gas Saver | Yes |
| On Time | 5.00 |
| Flow | 15.0 |
| Split Ratio | 25.0 |
| Split Flow | 75.0 |

Detector Conditions - FID:

| | |
|---|---|
| Flame Enable | Yes |
| Setpoint | 300 |
| Oxidizer Flow | 400 |
| Fuel Flow | 30.0 |
| Flow Mode | Constant Makeup |
| Makeup/Combo Flow | 30.0 |

Channel Conditions:

| | |
|---|---|
| Select Source | Front Detector - Channel 1 |
| Sensitivity | HIGH |
| Sampling Rate | 10 |

Injection Volume: 2.0 μL
Run time: 16 minutes

### Example 2

### Materials and Methods

Elite Sunflower Cultivars Comprising Stabilized Characteristic Oil Traits

Reduced Saturate Sunflower (RSS) germplasm containing low saturate oil levels was developed. See U.S Patent Publication No. 2009/0169706 A1. RSS sunflower oils comprise about 4% or less total saturated fatty acids (e.g., about 3.5% or less total combined palmitic and stearic acid). In contrast, conventional sunflower lines possess seed oil content with about 13% total combined saturated fatty acids. This is a significant difference that may be used to identify and distinguish raw or unmodified sunflower oil obtained from RSS germplasm from sunflower oil obtained from a conventional sunflower line. Oils produced by plants comprising a RSS germplasm also generally contain high levels of unsaturated fatty acids (e.g., oleic acid).

A large number of sunflower plants comprising a low saturated fat oil trait (e.g., RSS sunflower) were developed through plant breeding techniques, and their characteristic seed oil profiles are provided in Table 2 and Tables 3-6. Fatty acid composition analysis of the total seed oil content for each line was completed via FAME analysis. The results of the RSS oil samples were quantified and the FAME amounts were determined.

As expected, the oils of these lines contained significantly reduced saturated oil levels as compared to the saturate oil levels of conventional sunflower oil which have been previously reported in the literature. The total combined palmitic and stearic acid content of these particular cultivars is about 4% or less (e.g., about 3.5% or less, and from about 2.7% to about 3.5%). Most of these cultivars also have a characteristic high oleic acid content. For example, particular cultivars have an oleic acid content that is at least about 88% (e.g., from about 88% to about 95%).

TABLE 2
Seed oil content of certain sunflower cultivars having a total saturated fat content less
than about 4%.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| HE08EE017480.001.06 | 1.87 | 0.03 | 0.57 | 93.52 | 2.55 | 3.05 | 2.44 | 96.64 |
| NS1982.8 | 2.09 | 0.08 | 0.55 | 79.40 | 15.99 | 3.10 | 2.64 | 95.94 |
| (HX07ME095915.001) | | | | | | | | |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.16 | 1.52 | 0.06 | 1.05 | 94.37 | 0.85 | 3.39 | 2.57 | 96.27 |
| NS1982.16/ | 2.29 | 0.05 | 0.65 | 67.37 | 28.19 | 3.48 | 2.94 | 96.21 |
| OND163R-1-05 | | | | | | | | |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |

TABLE 3
Seed oil content of certain low saturated fat sunflower cultivars having a total saturated fat content
higher than about 4%.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| NS1982.14-08 | 1.51 | 0.02 | 2.24 | 92.84 | 1.35 | 4.90 | 3.75 | 96.43 |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| NS1982.8/ | 1.37 | 0.01 | 1.70 | 91.93 | 2.83 | 4.32 | 3.07 | 96.46 |
| OND163R-12-90 | | | | | | | | |
| H757B/ | 4.25 | 0.09 | 1.13 | 37.87 | 55.45 | 5.90 | 5.38 | 94.45 |
| LS10670B-B-17-3-14.01 | | | | | | | | |
| H757B/ | 4.80 | 0.11 | 0.68 | 39.63 | 53.55 | 6.05 | 5.48 | 93.86 |
| LS10670B-B-17-3-02.18 | | | | | | | | |
| H757B/ | 4.01 | 0.08 | 1.37 | 38.48 | 54.68 | 6.07 | 5.38 | 94.53 |
| LS10670B-B-17-3-27.12 | | | | | | | | |
| H757B/ | 5.19 | 0.14 | 0.73 | 35.14 | 57.79 | 6.22 | 5.92 | 93.66 |
| LS10670B-B-17-3-16.02 | | | | | | | | |
| H757B/ | 4.99 | 0.09 | 1.25 | 17.97 | 74.37 | 6.81 | 6.24 | 93.59 |
| LS10670B-B-17-3-36.22 | | | | | | | | |

TABLE 4
Seed oil content of certain low saturated fat sunflower cultivars having an oleic acid content of
at least about 88%.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| HE08EE017480.001.06 | 1.87 | 0.03 | 0.57 | 93.52 | 2.55 | 3.05 | 2.44 | 96.64 |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.14-08 | 1.51 | 0.02 | 2.24 | 92.84 | 1.35 | 4.90 | 3.75 | 96.43 |
| NS1982.16 | 1.52 | 0.06 | 1.05 | 94.37 | 0.85 | 3.39 | 2.57 | 96.27 |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| NS1982.8/ | 1.37 | 0.01 | 1.70 | 91.93 | 2.83 | 4.32 | 3.07 | 96.46 |
| OND163R-12-90 | | | | | | | | |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |
| H757B/ | 4.25 | 0.09 | 1.13 | 37.87 | 55.45 | 5.90 | 5.38 | 94.45 |
| LS10670B-B-17-3-14.01 | | | | | | | | |

TABLE 5
Seed oil content of certain low saturated fat sunflower cultivars having a palmitic acid content of
about 3% or less.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| HE08EE017480.001.06 | 1.87 | 0.03 | 0.57 | 93.52 | 2.55 | 3.05 | 2.44 | 96.64 |
| NS1982.8 | 2.09 | 0.08 | 0.55 | 79.40 | 15.99 | 3.10 | 2.64 | 95.94 |
| (HX07ME095915.001) | | | | | | | | |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.14-08 | 1.51 | 0.02 | 2.24 | 92.84 | 1.35 | 4.90 | 3.75 | 96.43 |
| NS1982.16 | 1.52 | 0.06 | 1.05 | 94.37 | 0.85 | 3.39 | 2.57 | 96.27 |
| NS1982.16/ | 2.29 | 0.05 | 0.65 | 67.37 | 28.19 | 3.48 | 2.94 | 96.21 |
| OND163R-1-05 | | | | | | | | |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| NS1982.8/ | 1.37 | 0.01 | 1.70 | 91.93 | 2.83 | 4.32 | 3.07 | 96.46 |
| OND163R-12-90 | | | | | | | | |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |

TABLE 6
Seed oil content of certain low saturated fat sunflower cultivars having an oil content comprising at
least about 88% oleic acid and about 3% or less palmitic acid.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| HE08EE017480.001.06 | 1.87 | 0.03 | 0.57 | 93.52 | 2.55 | 3.05 | 2.44 | 96.64 |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.14-08 | 1.51 | 0.02 | 2.24 | 92.84 | 1.35 | 4.90 | 3.75 | 96.43 |
| NS1982.16 | 1.52 | 0.06 | 1.05 | 94.37 | 0.85 | 3.39 | 2.57 | 96.27 |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| NS1982.8/ | 1.37 | 0.01 | 1.70 | 91.93 | 2.83 | 4.32 | 3.07 | 96.46 |
| OND163R-12-90 | | | | | | | | |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |

### Example 3

### Sunflower Oil Hydrogenation

Sunflower seed from the Reduced Saturate Sunflower line, NS1982.8, was produced through traditional breeding methodologies. This Reduced Saturate Sunflower (RSS) line was deposited and made available to the public without restriction (but subject to patent rights), with the American Type Culture Collection (ATCC), 10801 University Boulevard, Manassas, Va., 20110. The deposit, designated as ATCC Deposit No. PTA-9677, was made on behalf of Dow AgroSciences LLC on Dec. 23, 2008. Characteristic seed oil from this line contains about 3.3% combined palmitic acid (16:0) and stearic acid (18:0) content. Stearin was produced via a hydrogenation method from oil obtained from the Reduced Saturate Sunflower line, NS1982.8, and compared to stearin that was produced via the hydrogenation method from conventional sunflower lines. FAME analysis of the NS1982.8 oil sample used, prior to hydrogenation, provided a determination of the sample's oil content: 1.3% C16:0; 2% C18:0; ˜92% C:18:1; and 4% C18:2.

Sunflower oil isolated from a conventional and the RSS sunflower line was hydrogenated using the following protocol. Initially, 1.100 kg of RSS or conventional sunflower oil was loaded into a Parr™ reactor (Moline, Ill.), and heated to 195° C. under a slight vacuum. A heat tape was wrapped to the discharge tube of the reactor to secure the discharge tube in place. In a beaker, 50 g of conventional or RSS sunflower oil was heated, and 1.2 g of N-820 Ni catalyst was added. The cocktail was stirred until the N-820 Ni catalyst pellets were dissolved. Once the Parr™ reactor reached a temperature of 195° C., the oil and catalyst mixture was drawn into the reactor with additional flushing of the beaker and discharge tube with 50 g of sunflower oil. Next, hydrogen gas was added at 50 psi.

After 120 minutes, the discharge tube was flushed with ˜3-5 mL of sunflower oil from the reactor. A collection of about 10 mL of the sunflower oil sample was made, bleaching clay was added to the oil, and it was then filtered. An iodine value (IV) was taken of the oil sample (American Oil Chemists' Society Test Method: AOCS Cd 1d-92), and, once the IV reached less than 5.0, the hydrogenation reaction was stopped. The oil within the reactor was cooled to 110° C., and 2% of Tonsil™ 126 bleaching clay (Sud Chemie, Louisville, Ky.) was added. The solution was mixed under a vacuum for 20 minutes and filtered.

A FAME analysis as described above in Example 1 was completed to determine the fatty acid profiles of the hydrogenated RSS and conventional sunflower oil. The results of the total seed oil content for the RSS and conventional sunflower lines are presented in Table 7.

The hydrogenation reaction for the RSS lines resulted in an increase of the concentration of stearin (C18:0). The increase in stearin levels was the product of the conversion of C18:1 and C18:2 to C18:0 by saturation of the C18:1 and C18:2 oils using the hydrogenation protocol. Surprisingly, the levels of stearin produced from the RSS lines (i.e., at least about 96% stearin) were significantly greater than the conventional sunflower line controls, which only resulted in a production of 86.2% stearin. These results demonstrate an unexpected benefit for the use of a new raw material, RSS oil, for the manufacture of higher purity stearin.

By using RSS oil, manufacturers will be able to hydrogenate the raw oil, thereby producing a higher purity stearin. The advantages of using RSS oil as compared to conventional sunflower are significant. Use of RSS oil requires the consumption of lower amounts of hydrogen gas, less energy needed for heating, and reduced processing times.

TABLE 7
The hydrogenated oil of Reduced Saturate Sunflower line was
quantitated via FAME analysis and compared to hydrogenated
oil obtained from conventional sunflower lines.

| | | Conventional |
|---|---|---|
| Line Name | RSS | Line |
| % Sats | 98.5% | 95.86% |
| C14:0 | — | 0.13% |
| C16:0 | 2.5% | 8.30% |
| C18:0 | 96.0% | 86.2% |
| C18:1 | — | 3.84% |
| C18:2 | — | 0.20% |
| C20:0 | — | 0.42% |
| C22:0 | — | 0.66% |
| C24:0 | — | 0.23% |
| Other | 1.5% | — |

Melt point = 52-53° C.

### Example 4

### Iodine Values

The IV determined for the hydrogenated RSS oil was used to determine the amount of saturation in fatty acids. Higher IV results correspond with more carbon double bonds that are present in the fat, and provide an indication of the amount of oxidation. Samples were dissolved in CCl₄, and 25 mL of 0.1 M Wijs solution was added. The reaction was allowed to run to completion in the dark for approximately 1 hour, or longer if necessary.

Deionized water was added, and the excess iodine was titrated with sodium thiosuphate. IV values were determined with a Mettler Titrator™ (Mettler Toledo, Columbus, Ohio). The iodine value is defined as the weight of iodine absorbed by 100 gm of an oil or fat.

The hydrogenated RSS oil gave an IV of 1.14.

### Example 5

### Synthesis of Fully-Saturated Sunflower Oil from Crude No-Sat Sunflower Oil

A sample of crude Reduced Saturate Sunflower oil (lot 2008-670-2) was obtained, and the sample appeared as a dark yellow oil. 2.20 g of the crude no-sat sunflower oil sample was placed into a 500 mL thick-walled hydrogenation vessel, and toluene (58 g) was added to give a colorless solution. The solution was degassed by bubbling a steam of nitrogen for 5 minutes. Palladium on activated carbon (5% by wt, 295 mg) was added.

The vessel was attached to a Parr™ Hydrogenator, and hydrogen gas was applied at 40 psi to the vessel only. After 4 hours, the pressure in the vessel had dropped to 33 psi. The vessel was removed, and the reaction mixture was passed through a 0.45 micron syringe filter to remove the catalyst. The resulting colorless solution was treated with ethyl acetate (60 mL) to give a colorless solution. A white precipitate formed slowly over 1 hour. The solid (0.467 g) was collected by vacuum filtration, and it had a melting point of 72-73° C.

### Example 6

### Synthesis of Fully-Saturated Sunflower Oil from Mid Oleic Sunflower Oil

A sample of mid-oleic sunflower oil (lot 2005-1031-0002) was obtained. Sunflower varieties can be produced that yield seeds having a mid oleic acid content (e.g., 55% to 75% oleic acid). Sunflower oils having such fatty acid contents have an oxidative stability that is higher than oils with a lower oleic acid content. The sample of mid-oleic sunflower oil appeared as a light yellow/colorless oil. 2.45 g of the mid-oleic sunflower oil was placed into a 500 mL thick-walled hydrogenation vessel, and toluene (48 g) was added to give a colorless solution. The solution was degassed by bubbling a steam of nitrogen for 5 minutes. Palladium on activated carbon (5% by wt, 295 mg) was added.

The vessel was attached to a Parr™ Hydrogenator, and hydrogen gas was applied at 40 psi to the vessel only. After 1 hour, the pressure in the vessel had dropped to 32 psi. An additional 2 hour resulted in no change in the vessel pressure. The vessel was removed, and the reaction mixture was passed through a 0.45 micron syringe filter to remove the catalyst. The resulting colorless solution was treated with ethyl acetate (60 mL) to give a colorless solution. A white precipitate formed slowly over 1 hour. The mixture was cooled to 0° C. in an ice bath, and the solid (1.2 g) was collected by vacuum filtration. This solid had a melting point of 70-71° C.

### Example 7

### Synthesis of Fully-Saturated Sunflower Oil from High Oleic Sunflower Oil

A sample of high-oleic sunflower oil (lot 2006-1032-0001) was obtained. Sunflower varieties can be produced that yield seeds having a high oleic acid content, comprising an oil content of at least 80% oleic acid. High oleic acid sunflower oil is a stable oil (without hydrogenation) with a neutral taste profile. High oleic sunflower oil is ideal for products or production processes requiring a nutritional vegetable oil with naturally high stability and additives. The high oleic sunflower oil sample appeared as a colorless oil. A sample of fully-saturated oil was also obtained. The fully-saturated sample appeared as a white flake wax. A qualitative determination of the solubility of the saturated oil sample was evaluated in different solvents (chloroform, toluene, ethyl acetate, THF, and methyl t-butyl ether), and the compound was only soluble in chloroform (>0.1 g/mL) and toluene (˜0.1 g/mL).

A sample of the high oleic sunflower oil (2.12 g) was placed into a 500 mL thick-walled hydrogenation vessel, and toluene (42 g) was added to give a colorless solution. The solution was degassed by bubbling a steam of nitrogen for 5 minutes. Palladium on activated carbon (5% by wt, 350 mg) was added. The vessel was attached to a Parr™ Hydrogenator, and hydrogen gas applied at 40 psi to the vessel only. After 1 hour, the pressure in the vessel had dropped to 34 psi. An additional 4 hour resulted in no change in the vessel pressure. The vessel was removed and stored under ambient conditions for 18 hours.

A small portion of the reaction medium (black suspension, 1 mL) was removed and passed through a 0.2 micron syringe filter to remove the catalyst, giving a colorless solution. The solvent was removed with a heavy stream of nitrogen (15 minutes) to give a white waxy solid. The solid was analyzed by ¹H-NMR, and compared to the ¹H-NMR spectrum of the starting oil. The NMR results indicated complete saturation of the high-oleic oil. The remaining reaction mixture was passed through a 0.45 micron syringe filter to remove the catalyst and the resulting colorless solution was treated with ethyl acetate (60 mL) to give a colorless solution. A white precipitate formed slowly over 1 hour. The mixture was cooled to 0° C. in an ice bath, and the white solid (0.537 g) was collected by vacuum filtration. The white solid had a melting point of 69-70° C., and it was analyzed by ¹H-NMR and EA.

TABLE 8
Fully-saturated sunflower oil analysis.

| | Total Trans | Total | | | |
|---|---|---|---|---|---|
| Sample | Fats | Saturates | C10:0 | C12:0 | C13:0 |
| High Stearic RBD Sunflower Oil | 0.04 | 23.05 | nd | nd | nd |
| RBD Alpha ETS Oil | 0.08 | 7.02 | nd | nd | nd |
| No Sat Sunflower RBD | 0.09 | 3.06 | 0.01 | nd | nd |
| RBD High Palmitic Sunflower | 0.04 | 18.74 | nd | nd | nd |
| High Oleic Sunflower | 0.01 | 7.76 | 0.02 | nd | nd |
| Crude DAS-extracted Reduced Sat | 0.04 | 3.47 | nd | nd | nd |
| Sunflower | | | | | |
| Mid Oleic Sunflower | 0.17 | 9.47 | nd | nd | 0.01 |

| Sample | C14:0 | C14:1 | C15:0 | C15:1 | C16:0 |
|---|---|---|---|---|---|
| High Stearic RBD Sunflower Oil | 0.03 | nd | 0.03 | nd | 4.01 |
| RBD Alpha ETS Oil | 0.03 | nd | 0.01 | nd | 2.92 |
| No Sat Sunflower RBD | 0.02 | nd | 0.01 | nd | 1.91 |
| RBD High Palmitic Sunflower | 0.03 | nd | 0.02 | nd | 15.6 |
| High Oleic Sunflower | 0.03 | nd | 0.01 | nd | 3.11 |
| Crude DAS-extracted Reduced Sat | 0.02 | nd | 0.01 | nd | 1.81 |
| Sunflower | | | | | |
| Mid Oleic Sunflower | 0.05 | nd | 0.02 | nd | 4.38 |

| Sample | C16:1 trans | C16:1 | C17:0 | C17:1 | C18:0 |
|---|---|---|---|---|---|
| High Stearic RBD Sunflower Oil | 0.03 | 0.03 | 0.08 | 0.03 | 15.48 |
| RBD Alpha ETS Oil | 0.03 | 0.07 | 0.03 | 0.04 | 2.7 |
| No Sat Sunflower RBD | 0.03 | 0.03 | 0.02 | 0.04 | 0.52 |
| RBD High Palmitic Sunflower | nd | 3.92 | 0.02 | 0.05 | 1.44 |
| High Oleic Sunflower | 0.02 | 0.07 | 0.04 | 0.05 | 3.23 |
| Crude DAS-extracted Reduced Sat | 0.03 | 0.03 | 0.03 | 0.07 | 0.9 |
| Sunflower | | | | | |
| Mid Oleic Sunflower | 0.01 | 0.08 | 0.04 | 0.04 | 3.62 |

| | | C18:1 | | | C18:2 |
|---|---|---|---|---|---|
| | C18:1 trans | trans | C18:1 | C18:1 | trans, |
| Sample | (petroselaidate) | (eliadate) | (Oleic) | (vaccinic) | trans |
| High Stearic RBD Sunflower Oil | nd | 0.01 | 68.47 | nd | nd |
| RBD Alpha ETS Oil | nd | 0.03 | 89.43 | nd | nd |
| No Sat Sunflower RBD | nd | 0.03 | 91.92 | nd | nd |
| RBD High Palmitic Sunflower | nd | 0.02 | 70.58 | 3.17 | nd |
| High Oleic Sunflower | nd | 0.06 | 86.92 | nd | nd |
| Crude DAS-extracted Reduced Sat | nd | 0.01 | 93.54 | nd | nd |
| Sunflower | | | | | |
| Mid Oleic Sunflower | nd | 0.1 | 59.52 | nd | nd |

| | | C18:3 | | | |
|---|---|---|---|---|---|
| Sample | C18:2 | gamma | C19:0 | C18:3 alpha | C20:0 |
| High Stearic RBD Sunflower Oil | 7.94 | 0.01 | 0.04 | 0.12 | 1.13 |
| RBD Alpha ETS Oil | 2.87 | nd | nd | 0.06 | 0.25 |
| No Sat Sunflower RBD | 3.95 | nd | 0.03 | 0.1 | 0.07 |
| RBD High Palmitic Sunflower | 2.9 | nd | 0.01 | 0.09 | 0.21 |
| High Oleic Sunflower | 4.56 | nd | 0.03 | 0.07 | 0.28 |
| Crude DAS-extracted Reduced Sat | 1.52 | nd | 0.03 | 0.08 | 0.1 |
| Sunflower | | | | | |
| Mid Oleic Sunflower | 28.94 | nd | 0.08 | 0.92 | 0.32 |

| | | | | C20:3 | |
|---|---|---|---|---|---|
| Sample | C20:1 trans | C20:1 | C20:2 | homogamma | C20:4 |
| High Stearic RBD Sunflower Oil | 0.01 | 0.11 | nd | nd | nd |
| RBD Alpha ETS Oil | 0.02 | 0.3 | nd | nd | nd |
| No Sat Sunflower RBD | 0.02 | 0.65 | nd | nd | nd |
| RBD High Palmitic Sunflower | 0.02 | 0.26 | nd | nd | nd |
| High Oleic Sunflower | 0.01 | 0.27 | nd | nd | nd |
| Crude DAS-extracted Reduced Sat | nd | 0.65 | nd | nd | nd |
| Sunflower | | | | | |
| Mid Oleic Sunflower | 0.06 | 0.32 | 0.02 | nd | nd |

| Sample | C20:3 | C22:0 | C20:5 | C22:1 trans | C22:1 |
|---|---|---|---|---|---|
| High Stearic RBD Sunflower Oil | nd | 2.01 | nd | nd | nd |
| RBD Alpha ETS Oil | nd | 0.77 | nd | nd | nd |
| No Sat Sunflower RBD | nd | 0.33 | nd | nd | 0.03 |
| RBD High Palmitic Sunflower | nd | 1.02 | nd | nd | 0.01 |
| High Oleic Sunflower | nd | 0.79 | nd | nd | nd |
| Crude DAS-extracted Reduced Sat | 0.07 | 0.41 | nd | nd | nd |
| Sunflower | | | | | |
| Mid Oleic Sunflower | nd | 0.78 | nd | nd | nd |

| Sample | C22:2 | C24:0 | C22:6 (DHA) | C24:1 |
|---|---|---|---|---|
| High Stearic RBD Sunflower Oil | nd | 0.3 | 0 | 0.01 |
| RBD Alpha ETS Oil | nd | 0.3 | nd | nd |
| No Sat Sunflower RBD | nd | 0.2 | nd | nd |
| RBD High Palmitic Sunflower | nd | 0.41 | nd | nd |
| High Oleic Sunflower | 0.03 | 0.26 | nd | nd |
| Crude DAS-extracted Reduced Sat | nd | 0.19 | nd | nd |
| Sunflower | | | | |
| Mid Oleic Sunflower | nd | 0.25 | nd | 0.03 |

TABLE 9
Fully Saturated Sunflower Oil Analysis

| | | Total | | | |
|---|---|---|---|---|---|
| | | Trans- | | | |
| Sample | Total Saturates | fats | C10:0 | C12:0 | C13:0 |
| Hyd. low sat. sunflower oil | 96.73 | 2.46 | nd | 0.02 | 0.03 |
| from crude oil (lot 2008- | | | | | |
| 670-2) | | | | | |
| Commercial F.H. Cotton | 99.14 | 0.19 | nd | 0.04 | nd |
| Commercial F.H. Palm | 99.44 | 0.29 | 0.11 | 1.13 | nd |
| Commercial F.H. Soybean | 99.24 | 0.28 | nd | 0.01 | nd |
| Hyd. High Oleic Sunflower | 99.84 | nd | nd | nd | nd |

| Sample | C14:0 | C14:1 | C15:0 | C15:1 | C16:0 |
|---|---|---|---|---|---|
| Hyd. low sat. sunflower oil | 0.04 | nd | 0.03 | nd | 1.62 |
| from crude oil (lot 2008- | | | | | |
| 670-2) | | | | | |
| Commercial F.H. Cotton | 0.62 | nd | 0.04 | nd | 22.16 |
| Commercial F.H. Palm | 1.60 | nd | 0.07 | 0.01 | 60.37 |
| Commercial F.H. Soybean | 0.12 | nd | 0.06 | nd | 11.27 |
| Hyd. High Oleic Sunflower | 0.05 | nd | 0.02 | nd | 5.24 |

| Sample | C16:1 trans | C16:1 | C17:0 | C17:1 | C18:0 |
|---|---|---|---|---|---|
| Hyd. low sat. sunflower oil | nd | nd | 0.07 | 0.12 | 93.63 |
| from crude oil (lot 2008- | | | | | |
| 670-2) | | | | | |
| Commercial F.H. Cotton | nd | nd | 0.26 | nd | 75.26 |
| Commercial F.H. Palm | nd | nd | 0.15 | nd | 35.40 |
| Commercial F.H. Soybean | nd | nd | 0.36 | 0.04 | 86.35 |
| Hyd. High Oleic Sunflower | nd | nd | 0.12 | nd | 91.90 |

| | | C18:1 | | | |
|---|---|---|---|---|---|
| | C18:1 trans | trans | C18:1 | C18:1 | C18:2 |
| Sample | (petroselaidate) | (elaidic) | (Oleic) | (vaccenic) | trans, trans |
| Hyd. low sat. sunflower oil | nd | 2.44 | 0.47 | nd | 0.02 |
| from crude oil (lot 2008- | | | | | |
| 670-2) | | | | | |
| Commercial F.H. Cotton | nd | 0.19 | 0.08 | nd | nd |
| Commercial F.H. Palm | nd | 0.29 | 0.16 | 0.01 | 0.00 |
| Commercial F.H. Soybean | nd | 0.27 | 0.14 | 0.01 | 0.01 |
| Hyd. High Oleic Sunflower | nd | nd | 0.00 | nd | nd |

| | | C18:3 | | | |
|---|---|---|---|---|---|
| Sample | C18:2 | gamma | C19:0 | C18:3 alpha | C20:0 |
| Hyd. low sat. sunflower oil | 0.04 | 0.06 | nd | nd | 0.74 |
| from crude oil (lot 2008- | | | | | |
| 670-2) | | | | | |
| Commercial F.H. Cotton | 0.02 | 0.05 | nd | nd | 0.43 |
| Commercial F.H. Palm | 0.01 | 0.01 | nd | nd | 0.45 |
| Commercial F.H. Soybean | 0.02 | 0.07 | nd | nd | 0.58 |
| Hyd. High Oleic Sunflower | nd | 0.05 | nd | nd | 0.77 |

| | | | | C20:3 | |
|---|---|---|---|---|---|
| Sample | C20:1 trans | C20:1 | C20:2 | homogamma | C20:4 |
| Hyd. low sat. sunflower oil | nd | nd | nd | nd | nd |
| from crude oil (lot 2008- | | | | | |
| 670-2) | | | | | |
| Commercial F.H. Cotton | nd | nd | nd | nd | nd |
| Commercial F.H. Palm | nd | nd | nd | nd | nd |
| Commercial F.H. Soybean | nd | nd | nd | nd | nd |
| Hyd. High Oleic Sunflower | nd | nd | nd | nd | nd |

| Sample | C20:3 | C22:0 | C20:5 | C22:1 trans | C22:1 |
|---|---|---|---|---|---|
| Hyd. low sat. sunflower oil | nd | 0.40 | nd | nd | nd |
| from crude oil (lot 2008- | | | | | |
| 670-2) | | | | | |
| Commercial F.H. Cotton | nd | 0.20 | nd | nd | nd |
| Commercial F.H. Palm | nd | 0.08 | nd | nd | nd |
| Commercial F.H. Soybean | nd | 0.36 | nd | nd | nd |
| Hyd. High Oleic Sunflower | nd | 1.30 | nd | nd | nd |

| Sample | C22:2 | C24:0 | C22:6 | C24:1 | Phospholipids |
|---|---|---|---|---|---|
| Hyd. low sat. sunflower oil | nd | 0.20 | nd | nd | nd |
| from crude oil (lot 2008- | | | | | |
| 670-2) | | | | | |
| Commercial F.H. Cotton | nd | 0.11 | nd | nd | nd |
| Commercial F.H. Palm | nd | 0.07 | nd | nd | nd |
| Commercial F.H. Soybean | nd | 0.12 | nd | nd | nd |
| Hyd. High Oleic Sunflower | 0.05 | 0.46 | nd | nd | |

| | | | | | Free fatty |
|---|---|---|---|---|---|
| Sample | Polymers | TAGs | DAGs | MAGs | acids |
| Hyd. low sat. sunflower oil | nd | 95.88 | nd | nd | 4.13 |
| from crude oil (lot 2008- | | | | | |
| 670-2) | | | | | |
| Commercial F.H. Cotton | 0.26 | 99.74 | nd | nd | nd |
| Commercial F.H. Palm | 0.47 | 99.34 | nd | nd | 0.19 |
| Commercial F.H. Soybean | nd | 100 | nd | nd | nd |
| Hyd. High Oleic Sunflower | | | | | |

What may be claimed is:

1. A method for producing a high purity tristearin, the method comprising:
providing sunflower oil comprising no more than about 4% total saturated fat; and
hydrogenating the sunflower oil.

2. The method according to claim 1, wherein the sunflower oil comprises at least about 88% oleic acid (18:1).

3. The method according to claim 1, wherein the sunflower oil comprises at least about 92% oleic acid (18:1).

4. The method according to claim 1, wherein the sunflower oil comprises less than about 3% combined 16:0 and 16:1 fatty acids.

5. The method according to claim 1, wherein the sunflower oil comprises less than about 4% palmitic acid (16:0).

6. The method according to claim 1, wherein the sunflower oil comprises less than about 3% palmitic acid (16:0).

7. The method according to claim 1, wherein the sunflower oil comprises at least about 90% oleic acid (18:1).

8. The method according to claim 1, wherein the sunflower oil comprises at least about 92% oleic acid (18:1).

9. The method according to claim 1, wherein the sunflower oil comprises less than or equal to about 4% total combined palmitic acid (16:0) and stearic acid (18:0).

10. The method according to claim 1, wherein the sunflower oil comprises less than or equal to about 3.3% total combined palmitic acid (16:0) and stearic acid (18:0).

11. The method according to claim 1, wherein the sunflower oil comprises up to about 94% oleic acid (18:1) and less than about 4% palmitic acid (16:0).

12. The method according to claim 1, wherein the sunflower oil comprises up to about 94% oleic acid (18:1) and less than about 2.1% palmitic acid (16:0).

13. The method according to claim 1, wherein the hydrogenated sunflower oil comprises a combined stearic acid and palmitic acid content of at least about 98% of the total fatty acids in the hydrogenated sunflower oil.

14. The method according to claim 1, wherein hydrogenating the sunflower oil comprises heating the sunflower oil with a metal catalyst in the presence of pressurized hydrogen gas.

15. A high purity tristearin produced by the method of claim 1.

16. The high purity tristearin of claim 10, wherein the tristearin comprises a total stearic acid content of at least 96%.

17. The high purity tristearin of claim 10, wherein the tristearin comprises a combined content of stearic acid and palmitic acid of at least 98% of the total fatty acids in the oil.

18. A method of producing a high purity tristearin, the method comprising:
providing sunflower oil comprising at least about 88% oleic acid (18:1); and
hydrogenating the sunflower oil.

19. The method according to claim 18, wherein the sunflower oil comprises less than about 4% palmitic acid (16:0).

20. The method according to claim 18, wherein the sunflower oil comprises less than about 3% palmitic acid (16:0).

21. The method according to claim 18, wherein the sunflower oil comprises at least about 90% oleic acid (18:1).

22. The method according to claim 18, wherein the sunflower oil comprises at least about 92% oleic acid (18:1).

23. The method according to claim 18, wherein the sunflower oil comprises less than or equal to about 4% total combined palmitic acid (16:0) and stearic acid (18:0).

24. The method according to claim 18, wherein the sunflower oil comprises less than or equal to about 3.3% total combined palmitic acid (16:0) and stearic acid (18:0).

25. The method according to claim 18, wherein the sunflower oil comprises up to about 94% oleic acid (18:1) and less than about 4% palmitic acid (16:0).

26. The method according to claim 18, wherein the sunflower oil comprises up to about 94% oleic acid (18:1) and less than about 2.1% palmitic acid (16:0).

27. The method according to claim 18, wherein the hydrogenated sunflower oil comprises a combined stearic acid and palmitic acid content of at least about 98% of the total fatty acids in the hydrogenated sunflower oil.

28. The method according to claim 18, wherein hydrogenating the sunflower oil comprises heating the sunflower oil with a metal catalyst in the presence of pressurized hydrogen gas.

29. A high purity tristearin produced by the method of claim 18.

30. The high purity tristearin of claim 29, wherein the tristearin comprises a total stearic acid content of at least 96%.

31. The high purity tristearin of claim 29, wherein the tristearin comprises a combined content of stearic acid and palmitic acid of at least 98% of the total fatty acids in the oil.
